(19) United States
(12) Patent Application Publication
(10) Pub. No.: US 2003/0118267 A1
(43) Pub. Date: Jun. 26, 2003

(54) Isolation of microwave transmission lines

(76) Inventors: Eric M. Kimber, Paignton (GB); Christopher Clarke, Torquay (DE); Tim T. Lester, Kanata (CA); Iain Benson, Church Crookham (GB); Michael P. Grimshaw, Church Crookham (GB)

Correspondence Address: William M. Lee, Jr., LEE, MANN, SMITH, MCWILLILAMS, SWEENEY & OHLSON, P.O. Box 2786, Chicago, IL, 60690-2786, US

(21) Appl. No.: 10/032,416

(22) Filed: Dec. 21, 2001

(51) Int. Cl. G02B 6/12

(52) U.S. Cl. 385/14; 385/131

(57) ABSTRACT

An optical waveguide is formed over a substrate, with an insulating planarization layer formed adjacent the optical waveguide and level with the top of the waveguide A microwave transmission line is formed over the planarization layer and overlies a top surface of the optical waveguide. In this circuit, isolation of a microwave transmission line is provided by forming the line over a planarization layer which fills the space adjacent to an optical waveguide structure. The transmission line can then contact electrically the top surface of the waveguide structure but is isolated from the substrate which supports the waveguide.

### BACKGROUND OF THE INVENTION

The invention relates to the isolation of components in integrated circuits, particularly to the formation of an insulating substrate area to enable microwave transmission lines to be formed over the insulating area. The formation of microwave transmission lines on an insulating substrate is desirable to reduce microwave loss from the transmission lines.

Integrated circuits are formed within a semiconductor wafer by using a series of well-known techniques such as thin film deposition, diffusion, ion implantation, etc. in combination with photolithography. This results in the formation of a variety of active and passive components near one surface of the wafer. These components can be connected together by means of transmission lines carrying high frequency signals.

The invention is particularly directed to circuits for use in optical communications systems. In modern optical communications systems, the frequencies with which optical carriers are modulated have increased progressively in recent years. Current optical systems transfer data at 40 Gb/seconds, and this requires an electrical signal with a 40 GHz component to be modulated onto a higher frequency optical carrier. The transmission of electrical signals with these frequencies, in the microwave band, is subject to significant microwave loss, and there is therefore a need to isolate the transmission lines to reduce this loss.

The need to electrically isolate various components, sub circuits and/or transmission lines from one another is well known. Shallow and deep trench isolation is now commonly used. In these techniques, trenches with near vertical sides are etched between the circuits and then filled with dielectric materials.

There are other techniques for isolating different substrate areas from each other, such as ion implantation techniques. These techniques are suitable for isolating different substrate areas from each other. However, for microwave transmission lines, the need is to isolate the transmission lines from the semiconducting substrate over which the lines are to be formed.

The invention is particularly directed to integrated circuits for optical communications systems, which integrated circuits include optical waveguides, and where a microwave transmission line is to contact the optical waveguide structure. An example of such a circuit is an electro-optic modulator, in which a microwave electrical signal is used to modulate an optical carrier confined within an optical waveguide.

Electro-optic modulators (EOM) employ electric fields to control the propagation of light through their constituent parts and are widely used in optical data transfer and processing. There are two different types of electro optic modulators, electro-refraction modulators and electro-absorption modulators. Electro-refraction modulators rely on changes in the index of refraction of a material induced by an applied electric field to modulate the propagation of light through the modulator. One example of an electro-refraction modulator is based on a Mach-Zehnder interferometer. An incident light beam is split into two beams which propagate through the device on different paths and are subsequently recombined. An applied electric field alters the refractive index of the material along one or both of the paths to produce constructive or destructive interference when the beams are subsequently recombined.

Electro-absorption modulators achieve the desired light modulation by modifying the light absorbing properties of a material with an electric field. Materials comprising multiple quantum well (MQW) structures are particularly suitable for use in such devices.

Electro-optic modulators for optical communications systems require microwave transmission lines for the electrical signal as well as optical waveguides for the optical carriers. Integrated circuits incorporating waveguides typically use compound semiconductors, most commonly Gallium Arsenide, and the invention provides a process for forming insulating regions in such semiconductor substrates.

There are two conventional techniques which have been employed for forming insulating areas within a Gallium Arsenide substrate over which a transmission line can be formed. In one technique, the transmission line is formed over an air bridge, so that the conducting layers of the semiconductor substrate have been removed from beneath the transmission line. This gives a fragile structure and a potentially low yield process. A preferred approach provides isolation in a region in which the conductivity of the semiconductor layer is destroyed by proton bombardment. This results in the formation of semi-insulating regions. Transmission lines can then be formed over the semi-insulating regions. These regions can also extend through the full substrate to provide isolation between different circuit areas.

Although the proton bombardment technique provides a high yield process, a problem with this approach is that relatively high energy radiation (typically 800 keV to 2 MeV) must be used. At these energies, the ion implantation process is hazardous as it produces radiation by-products.

### SUMMARY OF THE INVENTION

According to the invention, there is provided an integrated circuit comprising;

a semiconductor substrate;

an optical waveguide formed over the substrate;

an insulating planarization layer formed adjacent the optical waveguide and level with the top of the waveguide; and

a microwave transmission line formed over the planarization layer and overlying a top surface of the optical waveguide.

In this circuit, isolation of a microwave transmission line is provided by forming the line over a planarization layer which fills the space adjacent to an optical waveguide structure. The transmission line can then contact electrically the top surface of the waveguide structure but is isolated from the substrate which supports the waveguide.

The insulating planarization layer preferably comprises a TEOS layer (Tetra-ethyl-ortho-silicate, otherwise known as tetraethoxysilane or tetraethyl oxysilane). TEOS processing has been employed in the silicon industry as a planarization, material and interconnect dielectric. The TEOS material provides high resistivity and low microwave loss.

The semiconductor substrate preferably comprises a compound semiconductor, preferably Gallium Arsenide-based. Such semiconductors are widely used for circuits including optical waveguides. For example, the optical waveguide may comprise a multiple layer structure, in which a substantially undoped Gallium Arsenide layer is sandwiched between substantially undoped Aluminium Gallium Arsenide layers.

The circuit may comprise an electro-optic modulator, wherein two optical waveguide sections are formed over the substrate, and wherein a respective transmission line for each waveguide section is formed over the planarization layer. In this way, a conventional Mach-Zehnder electro-refraction modulator structure may be formed

The waveguide sections may be parallel and spaced apart, the spacing between the waveguide sections being filled with the planarization layer. Alternatively, an air gap may be provided in the spacing between the waveguide sections. This lowers the risk of adverse strain effects on the waveguide.

The invention also provides a method of fabricating an integrated circuit comprising;

providing a semiconductor substrate;

depositing multiple semiconductor layers over the substrate;

patterning the multiple layers to define an optical waveguide stack formed over the substrate, the multiple layers being removed from the lateral sides of the waveguide stack;

depositing a planarization layer to fill the sides of the waveguide stack with a planarization layer to the same height as the waveguide stack; and

forming a microwave transmission line over the planarization layer and contacting a top surface of the optical waveguide stack.

This method provides a high yield process for isolating a microwave transmission line from an underlying substrate. Again, the insulating planarization layer preferably comprises TEOS layer and the semiconductor is preferably Gallium Arsenide-based.

The method can be used to fabricate an electro-optic modulator, wherein the patterning of the multiple layers defines two optical waveguide stacks, and wherein a respective transmission line for each waveguide stack is formed over the planarization layer.

### BRIEF DESCRIPTION OF THE DRAWINGS

Example of the invention will now be described in detail with reference to the accompanying drawings, in which:

FIG. 1 shows a first example of circuit in accordance with the invention;

FIG. 2 shows a second example of circuit in accordance with the invention;

FIG. 3 shows a third example of circuit in accordance with the invention; and

FIG. 4 shows an electro-optic modulator of the invention.

The same reference numerals have been used in different figures to denote the same components.

### DETAILED DESCRIPTION

FIG. 1 shows a circuit of the invention, in particular a Gallium Arsenide (GaAs) electro-optic modulator. A key aspect of a transmission line for GaAs is that it is a slow-wave line, namely it is capacitively loaded to slow the electrical signal down. In the context of an electro-optic modulator, the electrical signal is slowed to the same velocity as the optical signal in the waveguide.

The circuit comprises an undoped GaAs substrate 10. A seed layer 12 and a doped conduction layer 14 are patterned over the substrate, and the conduction layer 14 defines a d.c. electrode for the modulator.

Two waveguide stacks 16, 18 are formed over the common d.c. electrode 14. Each waveguide stack comprises one or more lower undoped Aluminium Gallium Arsenide (AlGaAs) layers 20, an undoped GaAs layer 22 and an upper undoped AlGaAs layer 24. A top undoped GaAs Schottky contact layer 26 is provided at the top of each waveguide stack.

In operation of the modulator, a voltage is applied to the d.c. electrode which has the effect of reverse biasing the Schottky diodes, and the transfer of signal into the waveguide is based on an electric field effect.

This stack is a well known waveguide configuration, in which an optical signal of appropriate frequency is confined in the undoped GaAs layer 22. To form the waveguide sticks, the required multiple semiconductor layers are deposited over the full area of the substrate, and these are then patterned to define the stacks, by removing the layers from all other areas of the substrate.

In the example of FIG. 1, both sides of the waveguide stacks are filled with a TEOS (tetra-ethyl-orthosilicate) planarization layer 30. The use of TEOS is known in the silicon processing industry as a planarization layer, and the techniques for depositing TEOS will be known to those skilled in the art.

The TEOS planarization layer provides a uniform upper surface on which conducting electrodes 32 can be formed. One waveguide stack is contacted by a ground electrode 32a and the other is contacted by a signal electrode 32b carrying the signal to be modulated on to the optical signal carrier. The signal electrodes 32a and 32b together form a microwave transmission line.

In this circuit, isolation of the microwave transmission line is provided by forming the line over a planarization layer 30 which fills the space adjacent the optical waveguides. In the spice adjacent the optical waveguides, the conducting layers of the semiconductor substrate have been removed and replaced by the planarization layer.

The waveguides 16, 18 are parallel and spaced apart, and in the example of FIG. 1, the spacing between the waveguide sections is filled with the planarization layer 30.

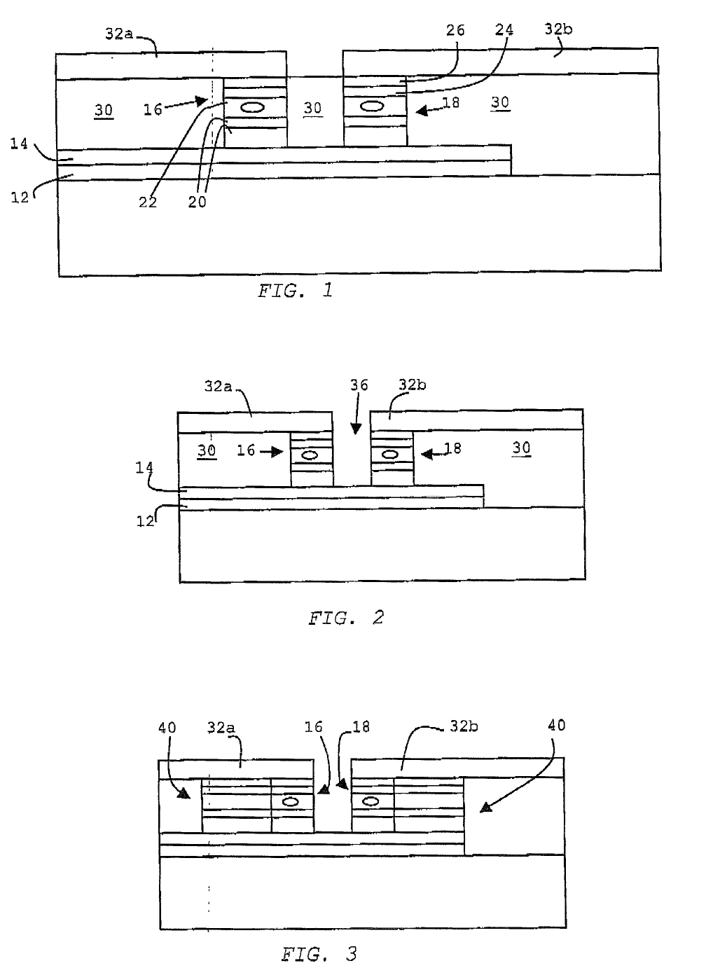

Alternatively, and as shown in FIG. 2, an air gap 36 may be formed by the removal of the TAOS material after the electrodes 32a, 32b have been formed, or by leaving the GaAs material between the waveguides in place during TEOS processing and etching the waveguides after the TEOS process, removing the excess GaAs. This air gap is thus provided in the spacing between the two waveguides 16, 18 and lowers the risk of adverse strain effects on the waveguides.

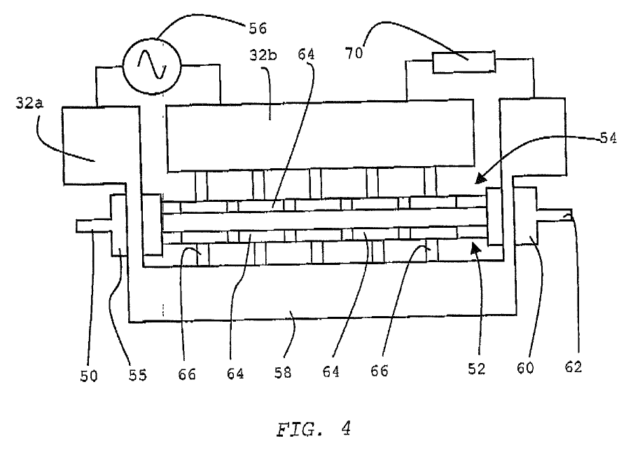

FIG. 3 shows a further modification in which the processing of the layers of the waveguide stacks also leaves thin bridge areas 40 (also shown in FIG. 4). These function as mechanical support structures.

As outlined above, the circuit of FIGS. 1 to 3 is an electro-optic modulator. The operation of the modulator will now be described briefly with reference to FIG. 4. A waveguide 50 is split into two paths 52, 24 by an optical splitter 55. An input signal 56 is applied between electrodes 32a and 32b. One electrode 32a may be a ground electrode and includes a bar 58 positioned adjacent one of the paths 52. The other electrode 32b, carrying microwave frequency signals, includes a bar positioned adjacent the other path 54. The electric field applied by the signal alters the refractive index of the material along the path 54 and/or 52 to produce constructive or destructive interference when the beams are subsequently recombined at the coupler 60 to form the output 62.

The electrodes 32a, 32b include metal pads 64 which act as capacitive elements for capacitive loading, and also act to modulate the optical field inside the waveguide. These pads 64 are connected to the electrode bars by bridges 66.

An electrical output signal is recovered across load 70.

The operation of a Mach-Zehnder type modulator will be well known to those of ordinary skill in the art.

The processes used to manufacture the circuit of the invention have not been described in detail, as conventional semiconductor processing techniques can be employed, which will be well known to those of ordinary skill in the art.

In the example above, the insulating planarization layer is formed from TEOS. Whilst this is the preferred embodiment, other layers may be used, such as spin on glass (SOG). Furthermore, the TEOS may be Plasma Enhanced (so called PETEOS).

The apparatus of the invention benefits from very good depth of isolation for the transmission lines.

1. An integrated circuit comprising;
a semiconductor substrate;
an optical waveguide formed over the substrate;
an insulating planarization layer formed adjacent the optical waveguide and level with the top of the waveguide; and
a microwave transmission line formed over the planarization layer and overlying a top surface of the optical waveguide.

2. A circuit as claimed in claim 1, wherein the insulating planarization layer comprises a tetra-ethylortho-silicate (TEOS) layer.

3. A circuit as claimed in claim 1, wherein the semiconductor substrate comprises a compound semiconductor.

4. A circuit as claimed in claim 3, wherein the semiconductor is Gallium Arsenide-based.

5. A circuit as claimed in claim 1, wherein the optical waveguide comprise a multiple layer structure, in which a substantially undoped Gallium Arsenide layer is sandwiched between substantially undoped Aluminium Gallium Arsenide layers.

6. A circuit as claimed in claim 1 comprising an electro-optic modulator, wherein two optical waveguide sections are formed over the substrate, and wherein a respective transmission line for each waveguide section is formed over the planarization layer.

7. A circuit as claimed in claim 6, wherein the waveguide sections are parallel and spaced apart, the spacing between the waveguide sections being filled with the planarization layer.

8. A circuit as claimed in claim 6, wherein the waveguide sections are parallel and spaced apart, an air gap being provided in the spacing between the waveguide sections.

9. A circuit as claimed in claim 8, wherein semiconductor portions are provided adjacent the waveguide sections for supporting the transmission lines.

10. A circuit as claimed in claim 6, wherein a common conduction layer is provided beneath the waveguide sections.

11. A circuit as claimed in claim 6, wherein the insulating planarization layer comprises a tetra-ethylortho-silicate TEOS) layer.

12. A circuit as claimed in claim 6, wherein the semiconductor is Gallium Arsenide-based.

13. A method of fabricating an integrated circuit comprising:
providing a semiconductor substrate;
depositing multiple semiconductor layers over the substrate;
patterning the multiple layers to define an optical waveguide stack formed over the substrate, the multiple layers being removed from the lateral sides of the waveguide stack;
depositing a planarization layer to fill the sides of the waveguide stack with a planarization layer to the same height as the waveguide stack; and
forming a microwave transmission line over the planarization layer and contacting a top surface of the optical waveguide stack.

14. A method as claimed in claim 13, wherein the insulating planarization layer comprises a tetra-ethylortho-silicate (TEOS) layer.

15. A method, as claimed in claim 13, wherein the semiconductor is Gallium Arsenide-based.

16. A method as claimed in claim 13, wherein the multiple semiconductor layers comprise a substantially undoped Gallium Arsenide layer sandwiched between substantially undoped Aluminium Gallium Arsenide layers.

17. A method as claimed in claim 13 for fabricating an electro-optic modulator, wherein the patterning of the multiple layers defines two optical waveguide stacks, and wherein a respective transmission line for each waveguide stack is formed over the planarization layer.

18. A method as claimed in claim 17, wherein the waveguide stacks are parallel and spaced apart, and wherein the spacing between the waveguide sections is filled with the planarization layer.

19. A method as claimed in claim 17, the planarization layer is not formed between the waveguide stacks.

20. A method as claimed in claim 17, wherein the patterning of the multiple layers further defines bridge portions adjacent the waveguide stacks.
